(19) United States
(12) Patent Application Publication
(10) Pub. No.: US 2016/0157019 A1
(43) Pub. Date: Jun. 2, 2016

(54) HEARING AID COMPATIBLE MOBILE SPEAKER

(71) Applicant: KNOWLES IPC (M) SDN. BHD., Penang (MY)

(72) Inventors: Ernst Tomas, Strasshof an der Nordbahn (AT); Ernst Pospischil, Guntramsdorf (AT); Susanne Windischberger, Vienna (AT)

(21) Appl. No.: 14/901,528

(22) PCT Filed: Jun. 25, 2014
(86) PCT No.: PCT/MY2014/000192

§ 371 Date: Dec. 28, 2015

Related U.S. Application Data
(60) Provisional application No. 61/839,358, filed on Jun. 25, 2013.

(51) Int. Cl. H04R 9/06; H04R 1/02; H04R 9/04; H04R 9/02

(52) U.S. Cl. CPC H04R 9/06; H04R 9/025; H04R 1/025; H04R 9/045; H04R 2499/11

(57) ABSTRACT

A speaker including a single coil for both normal voice and for creating an HAC field. A large coil may be provided in combination with a strong magnet. The components of the speaker may be designed so as to maximize the space available for the voice coil and for the magnet.

### CROSS-REFERENCE TO RELATED APPLICATION

This application claims the benefit of U.S. provisional application No. 61/839,358, filed 25 Jun. 2013, which is hereby incorporated by reference in its entirety.

### BACKGROUND

a. Technical Field

The present disclosure generally relates to speakers for mobile phones, including speakers that feature hearing aid compatibility.

b. Background Art

Speakers, including speakers for mobile phones, may provide hearing aid compatibility (HAC). One feature of HAC is compatibility with hearing aids enabled with a telecoil (also known as a t-coil). To function with telecoil-enabled hearing aids (and to comply with standards for interoperability with telecoil-enabled hearing aids), a coil of the speaker must provide a certain of a particular magnitude) magnetic field at a certain distance from the phone. Such a field is referred to herein as an HAC filed.

To generate an HAC field, some mobile phone speakers include two coils: a voice coil for output of acoustic signals, and a second larger coil for production of the HAC field. With two coils, electrical contacts of the coils are more likely to fail and the speaker materials are more expensive than a single-coil speaker. Furthermore, the cost of assembly rises when two coils have to be produced, placed, handled, glued and contacted.

In known mobile phone speaker designs, there is generally not enough space in the phone to place a sufficiently large voice coil in the speaker to produce an HAC field with the voice coil. Thus, in known speakers, a second coil may be provided, for example, at the cover of the speaker.

### SUMMARY

To overcome one or more deficiencies of known speakers, a speaker may include a single coil for both acoustic output and for creating an HAC field. To do so, a large coil may be provided in combination with a strong magnet. The components of the speaker may be designed so as to maximize the space available for the voice coil and for the magnet.

An embodiment of a speaker for a mobile device that is capable of providing hearing aid compatibility and improves upon known speakers may include a voice coil, a membrane coupled to the voice coil, a magnet, and a magnetically-conductive pot. The magnet may be disposed so as to create a magnetic field with which the voice coil may interact. The pot may support the magnet and may comprise a body having a generally planar surface that is parallel with the membrane and a plurality of retaining members, the retaining members extending orthogonally from the planar surface so as to contain the magnet within the basket assembly.

Another embodiment of a speaker for a mobile device that is capable of providing hearing aid compatibility and improves on known speakers may include a voice coil, a membrane coupled to the voice coil, a magnet, and a basket assembly. The basket assembly may include an electrical contact portion, the electrical contact portion electrically coupled with the coil and extending around an exterior portion of the basket assembly. The electrical contact portion may comprise an injection-molded metal, such as steel, in an embodiment.

Another embodiment of a speaker for a mobile device that is capable of providing hearing aid compatibility and improves on known speakers may include a voice coil, a membrane coupled to the voice coil, a magnet, and a magnetically-conductive pot. The pot may be disposed so as to conduct magnetic flux from the magnet. The pot may include a generally planar surface parallel with the membrane and one or more indents in the planar surface, each of the one or more indents surrounding a ventilation port in the pot configured to permit the flow of air displaced by movement of the membrane. The speaker may further include a mesh disposed within each of the one or more indents so as to cover the ventilation port surrounded by the indent.

Features from the above-described speakers may be combined in a single embodiment. With one or more of the above-described features, a relatively large voice coil and a relatively large magnet may be provided in the speaker so that the speaker may provide an HAC field and acoustic output with a single coil. Additionally, the speaker may be sufficiently sturdy to survive the drops and tumbles common in the use of a mobile phone and other devices.

### BRIEF DESCRIPTION OF THE DRAWINGS

FIG. 1 is a diagrammatic cross-sectional view of a speaker using two separate coils to provide acoustic output and an HAC field.

FIG. 2 is a diagrammatic cross-sectional view of an embodiment of a speaker that may use a single coil for acoustic output and for an HAC field.

FIG. 3A is an isometric view of an embodiment of a pot that may be used in a speaker according to the present disclosure.

FIG. 3B is an isometric view of an embodiment of a pot and magnet that includes the pot of FIG. 3A.

FIG. 3C is an enlarged view of a portion of FIG. 3B.

FIG. 4 is an isometric view of a portion of an embodiment of a speaker, including a pot design comprising back venting holes and indents.

FIG. 5 is a diagrammatic top view of a portion of speaker including wire loops to connect a voice coil with externally-accessible electrical contacts.

FIG. 6 is a diagrammatic top view of an embodiment of a partial speaker assembly with a basket assembly having an integrated electrical contact structure.

FIG. 7 is an isometric view of the partial speaker assembly of FIG. 6.

FIG. 8 is an isometric view of the electrical contact structure of FIG. 6.

### DETAILED DESCRIPTION

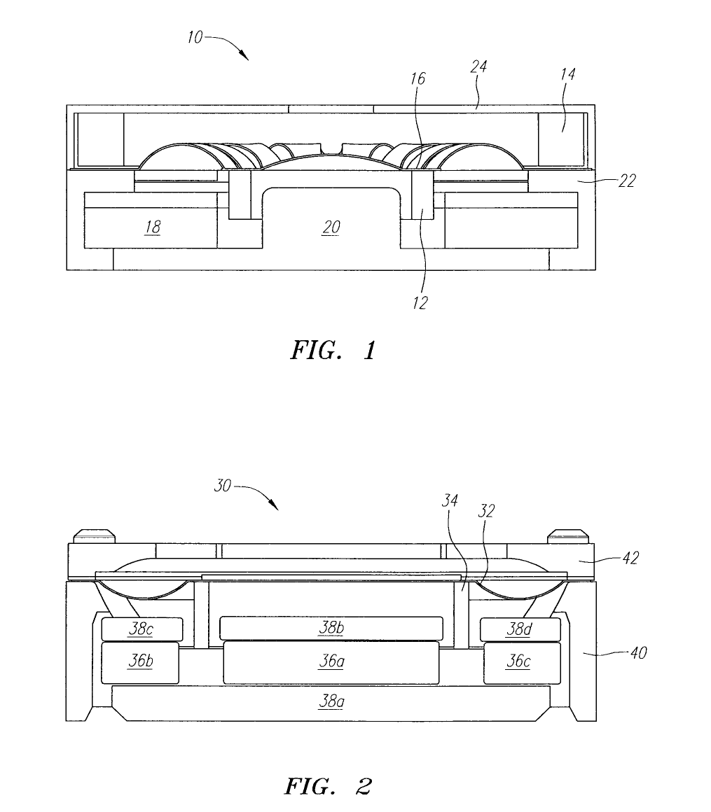

Referring to the figures, in which like reference numerals refer to the same or similar features in the various views, FIG. 1 is a diagrammatic cross-sectional view of a mobile speaker 10 that includes a first coil 12 for acoustic output and a second coil 14 for creating an HAC field. The speaker 10 may include a membrane 16, a voice coil 12, a magnet 18, a magnetically-conductive pot 20, a basket 22, a cover 24, and an HAC coil 14. The voice coil 12 may be coupled with the membrane 16 and may interact with a magnetic field produced by the magnet 18 and the pot 20 responsive to an electrical current driven through the voice coil 12 so as to actuate the membrane 16 to output an acoustic signal.

Due to the size constraints of a mobile device, the voice coil 12 may be too small to create a magnetic field sufficiently large to interact with a telecoil-enabled hearing aid proximate the speaker 10. As a result, a larger HAC coil 14 may be provided, for example, between the basket 22 and the cover 24. The HAC coil 14 may be stationary relative to the basket 22, as opposed to the voice coil 12 which may be movably coupled with the membrane 16 and may be movable relative to the magnet 18 and the basket 22. The HAC coil 14 may be significantly larger than the voice coil 12. For example, the voice coil 12 may have a volume of 1.5 cubic millimeters (mm³) or less, and the HAC coil 14 may be ten times or more larger than the voice coil.

FIG. 2 is a diagrammatic cross-sectional view of an embodiment of a speaker 30 that may use a single coil for acoustic output and for an HAC field. The speaker 30 may include a membrane 32, a coil 34, a magnet 36, a magnetically-conductive pot 38, a basket 40, and a cover 42. The voice coil 34 may be coupled with the membrane 32 and may interact with a magnetic field produced by the magnet 36 and conducted by the pot 38 responsive to an electrical current driven through the coil 34 so as to actuate the membrane 32 to produce acoustic output.

The coil 34 may be sufficiently large to create an HAC field. For example, the coil 34 may have a volume between about three (3) cubic millimeters and about four (4) cubic millimeters, in an embodiment. Still further, the coil 34 may have a volume of about 3.5 cubic millimeters. Accordingly, no second coil may be necessary for creating an HAC field. Several features may be included in the speaker 30 to accommodate the large coil 34 while fulfilling reliability, size, shape, and electrical input requirements of typical mobile devices.

The magnet 36 may be configured to provide a magnetic field with which the coil 34 may interact when an electrical current is driven through the coil 34 (i.e., such that the magnetic field produced by the coil 34 responsive to such a current interacts with the magnetic field produced by the magnet 36). The magnet 36 may comprise a permanent magnet, in an embodiment. The magnet 36 may comprise a single piece of magnetic material, in an embodiment. Alternatively, the magnet 36 may comprise multiple pieces of magnetic material. For example, as shown in FIG. 2, the magnet 36 may include three pieces: a central magnet 36a and two lateral magnets 36b, 36c. Each of the pieces of the magnet 36 may comprise the same materials, in an embodiment. In still another embodiment, the magnet 36 may comprise a five-piece construction or another construction.

With continued reference to FIG. 2, the magnet 36 may include a relatively large amount of magnetic material—i.e., more magnetic material than the speaker of FIG. 1—so as to create a strong enough magnetic field to sufficiently actuate the coil 34 and membrane 32 for acoustic output.

The basket 40 may be configured to receive and secure the pot 38. The basket 40 may comprise or may be made entirely of plastic, in an embodiment.

The pot 38 may be configured to conduct magnetic flux so as to create a continuous and focused magnetic field in conjunction with the magnet 36 for interaction with the coil 34. Accordingly, the pot 38 may include a magnetically-conductive material. For example, in an embodiment, the pot 38 may include or be made entirely of soft iron.

The pot may include a single unitary structure or multiple structures. For example, in the embodiment illustrated in FIG. 2, the pot may include four components: a lower pot portion 38a, a central top plate 38b, and lateral top plates 38c, 38d. Although described herein as part of the pot 38, the top plates 38b, 38c, 38d may be considered separate elements from the pot, in an embodiment, and may comprise the same materials as or different materials from the pot 38, in embodiments.

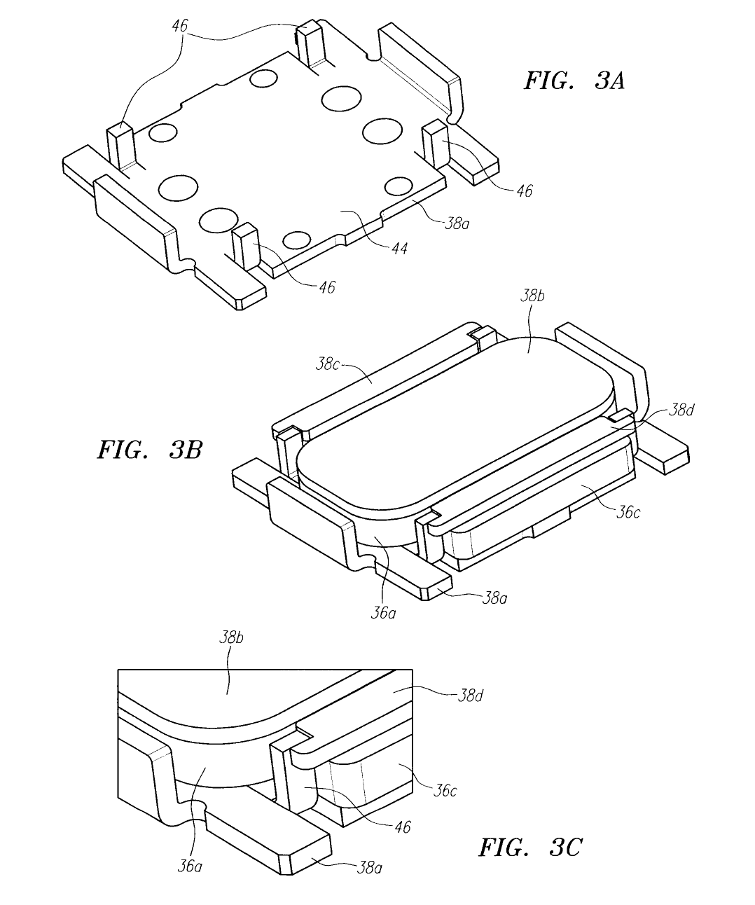

The pot 38 may be further configured to receive and secure the magnet 36 or one or more portions 36a, 36b, 36c of the magnet 36. The pot 38 may include one or more features that may not be found in a pot in known devices, which features may be configured to accommodate and secure the large amount of magnetic material included in the speaker 30. For example, the pot 38 (e.g., the lower pot portion 38a) may include retaining members. FIG. 3A is an isometric view of the lower pot portion 38a. FIG. 3B is an isometric view of the pot 38 securing a magnet 36, and FIG. 3C is an enlarged view of a portion of FIG. 3B.

The lower pot portion 38a may include a generally planar inner surface 44 configured to be placed in the finished speaker so as to be generally parallel to the membrane (see FIG. 2). The magnet 36, or one or more portions 36a, 36b, 36c of the magnet 36, may rest on the inner surface 44 of the lower pot portion 38a. The pot 38 (e.g., the lower pot portion 38a) may further comprise a plurality of retaining members 46 that extend in a direction generally orthogonal to the planar inner surface 44.

The retaining members 46 may comprise generally rectangular members having a height that is similar to (e.g., the same as or slightly larger than) the height of the magnet 36, in an embodiment. The retaining members 46 may be provided on multiple sides of the magnet 46, in an embodiment. For example, if the pot 38 and/or magnet 36 and/or a portion of the magnet 36 are generally rectangular, retaining members 46 may be provided on all four sides of the magnet or magnet portion. Further, in an embodiment, multiple retaining members 46 may be provided on one or more sides of the magnet 36 or magnet portion. For example, two retaining members 46 may be provided on each of two opposite sides (e.g., the longer sides) of the magnet 36 or a magnet portion, as illustrated in FIGS. 3A and 3B.

The magnet 36 may comprise one or more central magnets 36a and two or more side magnets, in an embodiment. For example, two lateral magnets 36b, 36c may be provided as side magnets. The central magnet 36a may be spaced apart from the side magnets 36b, 36c such that the coil (see FIG. 2) can propagate through a magnetic field between the central magnet 36a and the side magnets 36b, 36c. In an embodiment, the side magnets 36b, 36c may be disposed on opposite sides of the central magnet 36a. A direction in which a side magnet 36b, 36c is spaced from a central magnet 36a may be referred to herein as the lateral direction of the side magnet 36b, 36c. The perpendicular direction to the lateral direction may be referred to herein as the longitudinal direction of the side magnet 36b, 36c.

One or more of the retaining members 46 of the pot 38 may be configured in size, shape, and location to secure the side magnets 36b, 36c, in an embodiment, and/or one or more portions of the pot 38, such as the lateral top plates 38c, 38d. For example, a retaining member 46 may be placed at one or more longitudinal ends of the side magnets 36b, 36c. Still further, as shown in FIGS. 3A and 3B, retaining members 46 may be placed at each longitudinal end of each side magnet. Additionally or alternatively, one or more retaining members 46 may be placed at one or more lateral sides of a side magnet 36b, 36c or of the central magnet 36a or at one or more longitudinal sides of the central magnet 36a.

The retaining members 46 may secure the side magnets 36b, 36c from longitudinal movement, in an embodiment, to ensure device functionality through drops, tumbles, and the like. In an embodiment, the retaining members 46 and one or more portions of the side magnets 36b, 36c and/or one or more portions of the pot top plates 38c, 38d may include complementary features. For example, as illustrated in FIGS. 3B and 3C, the lateral top plates 38c, 38d may include one or more concave formations in which retaining members 46 may be disposed in the assembled device.

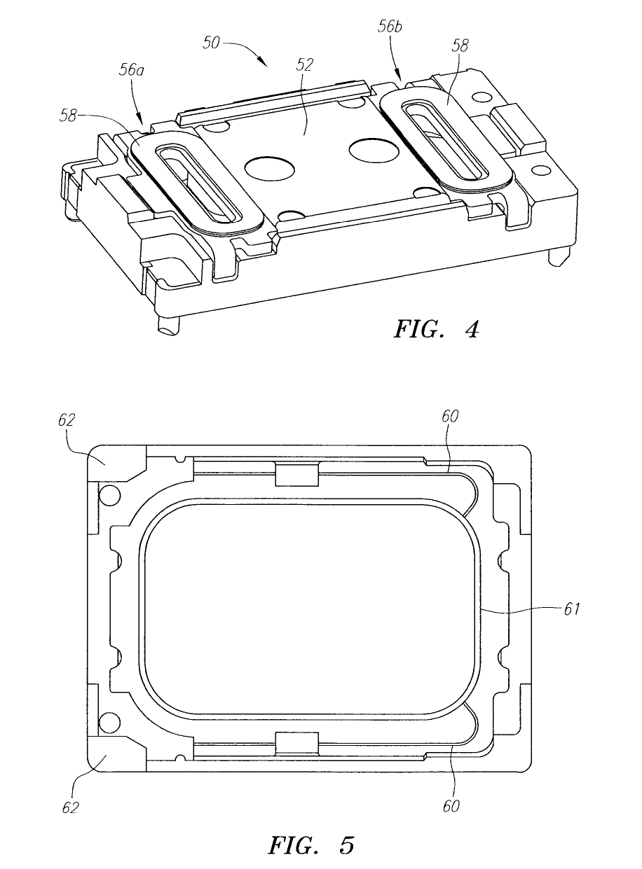

Another feature of a speaker according to the present disclosure that may accommodate a large coil and a large amount of magnetic material may be a back-vented pot. FIG. 4 is an isometric view of a portion of an embodiment of a speaker 50, including a pot 52 comprising back venting holes and dents.

In many known devices, back venting of the speaker is achieved via holes at the back of the basket, which holes may be covered with a mesh-material. In embodiments in which the basket is made of plastic, however, including back vents in the basket may compromise the structural integrity of the basket. Accordingly, as shown in FIG. 4, back vents may be provided in the pot, rather than in the basket.

Referring to FIG. 4, the pot 52 may include a generally planar back surface 54 and one or more back vents 56. For example, in an embodiment, the pot may include two back vents 56a, 56b. Each back vent 56 may include a rounded opening in the back surface 54 of the pot 52, such as an elliptical opening. Each back vent 56 may further include and may be defined within an indentation in the planar back surface 54 of the pot 52.

Each back vent 56 may be covered by a mesh material 58, in an embodiment. The mesh material 58 may be cover part or all of each vent 56, in an embodiment. The mesh material 58 may be disposed within the indentation within which the vent 56 is defined. As a result, the mesh material 58 may not extend outside of the envelope defined by the planar back surface 54 of the pot 52 (i.e., may not increase the thickness of the pot assembly). The mesh 58 may be coupled to the vent 56 to the portion of the pot surrounding the vent 56) with adhesive, in an embodiment.

Another feature of a speaker according to the present disclosure that may accommodate a large coil and a large amount of magnetic material may be an electrical signal-transmission infrastructure built into the basket.

One configuration for electrically coupling a coil 61 with another portion of the mobile device for providing a signal to the coil 61, which configuration is illustrated in FIG. 5, is to couple a loose wire loop 60 with the coil 61 and with a contact spring (not shown in FIG. 5), which contact spring is electrically coupled with a contact pad 62 that is accessible from outside the speaker.

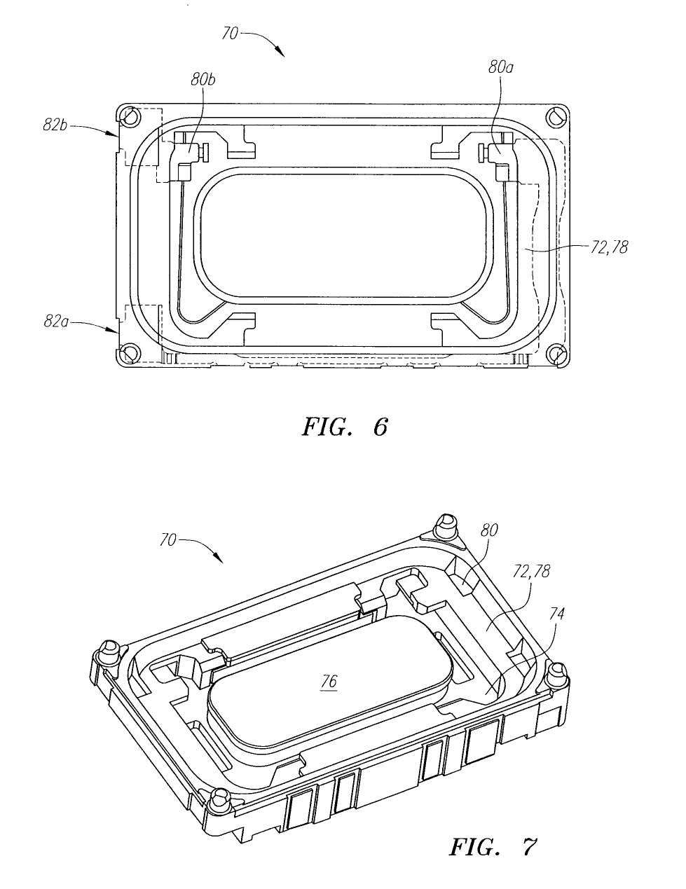

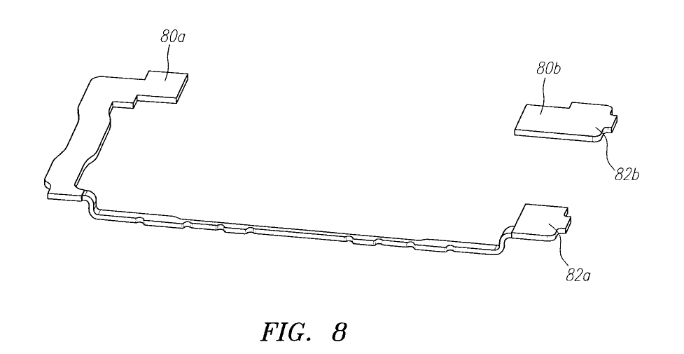

Another configuration for electrically coupling a coil with another portion of the mobile device for providing a signal to the coil is to integrate an electrical infrastructure in the basket. FIG. 6 is a top view of an embodiment of a partial speaker assembly 70 having an electrical infrastructure included in the basket. FIG. 7 is an isometric view of the partial speaker assembly 70 of FIG. 6. FIG. 8 is an isometric view of the electrical contact structure of FIG. 6. Referring to FIGS. 6-8, a partial speaker assembly 70 is illustrated that includes a basket assembly 72, a pot 74, and a magnet 76. The basket assembly 72 may include a body portion 78 and an electrical contact portion 80.

The electrical contact portion 80 of the of the basket assembly 72 may include a first electrical conduction portion 80a and a second electrical conduction portion 80b. The first and second electrical conduction portions 80a, 80b may comprise metal, in an embodiment. For example only, the first and second electrical conduction portions 80a, 80b may comprise steel or another electrically-conductive metal. Additionally or alternatively, the first and second electrical conduction portions 80a, 80b may comprise an electrically-conductive material other than metal. The first and second electrical conduction portions 80a, 80b may be injection-molded into the basket body portion 78, in an embodiment.

The first electrical conduction portion 80a may extend from a first side of the basket body 78, around the exterior of the basket body 78 (which may also be the exterior of the basket assembly 72), and provide a first external electrical contact 82a on a second side of the basket body 78, in an embodiment. The second electrical conduction portion 80b may also be provided on the second side of the basket assembly and may provide a second external electrical contact 82b. The coil may be electrically coupled with the first and second electrical conductions portions 80a, 80b with respective wire loops, in an embodiment.

The various features described herein may be provided in a single speaker even if illustrated and/or described separately herein. A speaker including one or more of the features illustrated and/or described herein may present numerous advantages over known speakers. For example, such a speaker may provide an HAC field and voice output with a single coil. As a result, the device may have a lower cost and fewer reliability problems by virtue of not requiring a second coil. The larger coil and larger magnet may result in a higher sound pressure level (SPL) than known mobile speakers. A basket assembly according to the present disclosure (e.g., including vertical retaining members) may offer improved performance in mechanical tests (e.g. drop test, tumble test, yoke test) and corresponding improved reliability. Finally, a basket assembly according to the present disclosure (e.g., including an injection-molded or otherwise integrated electrical contact infrastructure) may offer greater design flexibility to fulfill customer requirements for contact position.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although numerous embodiments of this invention have been described above with a certain degree of particularity, those skilled in the art could make numerous alterations to the disclosed embodiments without departing from the spirit or scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1. A speaker for a mobile device capable of providing hearing aid compatibility, the speaker comprising:
a coil;
a membrane coupled to the coil;
a first magnet and a second magnet spaced apart from each other disposed so as to create a magnetic field between the first and second magnets through which the coil may propagate; and
a magnetically-conductive pot supporting the first and second magnets, the pot comprising a generally planar inner surface that is parallel with the membrane and a plurality of retaining members, the retaining members being unitary with the inner surface and extending orthogonally from the inner surface so as to restrain at least one of the first and second magnets.

2. The speaker of claim 1, wherein the first magnet comprises a central magnet and the second magnet comprises a first lateral magnet, further comprising a second lateral magnet, wherein the coil is disposed so as to propagate between the central magnet and the two lateral magnets, wherein each of the two lateral magnets is restrained by a respective two or more of the retaining members.

3. The speaker of claim 1, further comprising a basket assembly, the basket assembly comprising a plastic body and an electrical contact portion, the electrical contact portion electrically coupled with the coil and extending around an exterior portion of the basket assembly.

4. The speaker of claim 3, wherein the electrical contact portion comprises an injection-molded metal.

5. The speaker of claim 4, wherein the electrical contact portion comprises steel.

6. The speaker of claim 1, wherein the pot further comprises:
a generally planar outer surface that is parallel with the membrane and one or more indents in the outer surface, each of the one or more indents surrounding a ventilation port in the pot configured to permit the flow of air displaced by movement of the membrane; and
a mesh disposed within each of the one or more indents so as to cover the ventilation port surrounded by the indent.

7. The speaker of claim 1, wherein the inner surface of the pot is disposed on a first side of the first or second magnet, wherein the speaker further comprises one or more top plates, disposed on a second side of the first or second magnet that is opposite the first side and in contact with one or more of the retaining members.

8. The speaker of claim 7, wherein each of the one or more top plates comprises the same materials as the pot.

9. The speaker of claim 1, wherein the pot comprises six or more retaining members.

10. The speaker of claim 1, wherein the inner surface of the pot is disposed on a first side of the first magnet and a first side of the second magnet, the speaker further comprising:
a first top plate disposed on a second side of the first magnet; and
a second top plate disposed on a second side of the second magnet, wherein the second top plate is in contact with one or more of the retaining members.

11. The speaker of claim 10, wherein the second top plate is in contact with two of the retaining members.

12. The speaker of claim 11, wherein the two retaining members with which the second top plate is in contact restrain lateral and longitudinal movement of the second top plate.

13. The speaker of claim 11, wherein the second magnet is in contact with the same two retaining members as the second top plate.

14. The speaker of claim 2, wherein an inner surface of the pot is disposed on a first side of the central magnet, a first side of the first lateral magnet, and a first side of the second lateral magnet, the speaker further comprising:
a central top plate disposed on a second side of the central magnet;
a first lateral top plate disposed on a second side of the first lateral magnet; and
a second lateral top plate disposed on a second side of the second lateral magnet;
wherein the first lateral top plate is in contact with one or more of the retaining members and the second lateral top plate is in contact with a different one or more of the retaining members.

15. The speaker of claim 14, wherein the first lateral top plate is in contact with two retaining members that restrain lateral and longitudinal movement of the first lateral top plate and the second lateral top plate is in contact with a different two contact members that restrain lateral and longitudinal movement of the second lateral top plate.
